(19) United States
(12) Patent Application Publication
(10) Pub. No.: US 2026/0080329 A1
(43) Pub. Date: Mar. 19, 2026

(54) DYNAMIC SCHEDULE CHANGE MANAGEMENT SYSTEM

(71) Applicant: NICE LTD., Ra'anana (IL)

(72) Inventors: Shilpa SHEGAONKAR, Pune (IN); Laukik PATIL, Bhiwandi (IN); Gaurav SURYAWANSHI, Pune (IN)

(21) Appl. No.: 18/888,919

(22) Filed: Sep. 18, 2024

(51) Int. Cl. G06Q 10/0631

(52) U.S. Cl. CPC G06Q 10/063116

(57) ABSTRACT

A system is adapted to automatically manage schedule change requests. The system includes a workforce management server in electronic communication with a manager computing device, and agent computing devices. The server receives a number of SCRs. Continuously, in real time, the server: receives, a new SCR; fetches n SCRs from the SCR database whose deadlines are nearest; computes a respective net staffing impact for each of the n SCRs; and generates a prompt for an AI model. For each of the n SCRs, the AI model determines a respective priority, places the n SCRs in order of their respective priorities; and suggests a respective action to approve or decline the SCR. The server updates a dynamic GUI on the manager computing device to display, in the order of their respective priorities, the n SCRs and their suggested actions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to a system and methods for dynamically managing staff schedule changes in real time. This dynamic schedule change management system and methods have particular, but not exclusive, utility for managing the schedules of call centers and other contact centers.

### BACKGROUND

Issues with current workforce management (WFM) tools in contact centers highlight critical challenges that can significantly impact operational efficiency and service quality. For example, managers may be overwhelmed with numerous pending schedule change requests (SCRs) from agents across different teams or skill units (SUs). This can create a bottleneck, as it may be difficult to track and prioritize these requests effectively. Often, managers lack a clear view of all pending requests, making it hard to identify which ones are urgent. Thus, critical requests may be overlooked, leading to operational disruptions.

Where managers are unaware of the deadline for each SCR, this can create delays in processing requests. Thus, requests may not be processed in a timely manner, leading to a backlog. Such delays can disrupt scheduling and staffing levels, causing a ripple effect on the contact center's efficiency. Similarly, unprocessed or delayed requests can lead to significant operational problems. For example, contact center agents may take time off without approval if their requests are not addressed, leading to unexpected staffing shortages. Also, unapproved requests can result in unplanned schedule changes, impacting service levels and customer satisfaction. The contact center may also, at times, face a lack of agents with specific skills, hindering the ability to handle specialized tasks or queries efficiently.

Currently, the management of time off requests and other scheduling requests is a significant source of complaints. Existing WFM solutions lack the capability to effectively address these issues. Accordingly, a long-felt need exists for improved WFM tools that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a dynamic schedule change management system that allows a manager to see a short list of highest-priority schedule change requests (SCRs), along with recommended actions for each SCR on the list. This list can be automatically and dynamically updated each time a new SCR is filed. The recommended actions are clickable, and can be implemented automatically if clicked. The dynamic schedule change management system disclosed herein has particular, but not exclusive, utility for workforce management (WFM) in call centers and other contact centers.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically manage schedule change requests. The system includes a workforce management server having a processor and a non-transitory computer readable medium operably coupled thereto, the server being in electronic communication with a manager computing device and a plurality of agent computing devices. The processor may include a query module, a net staffing calculator, a prompt generator, a generative artificial intelligence (Gen AI) model, and a dynamic graphical user interface (GUI), the server being in electronic communication with a schedule change request (SCR) database, a schedule database that includes a schedule, and a forecasting database. The computer readable medium may include a plurality of instructions stored in association therewith that are accessible to, and executable by, the processor, to perform operations which may include: with the workforce management server, receiving, from the plurality of agent computing devices, a plurality of SCRs, each SCR having a respective agent name, requested date, and deadline; storing the plurality of SCRs in the SCR database; and continuously, in real time: with the workforce management server, receiving, from an agent computing device of the plurality of agent computing devices, a new SCR, the new SCR having a respective deadline; storing the new SCR and its respective deadline in the SCR database; with the query module, fetching n SCRs from the SCR database whose deadlines are nearest; with the net staffing calculator, using the schedule database and the forecasting database, computing a respective net staffing impact for each SCR of the n SCRs; with the prompt generator, using the n SCRs, the n respective deadlines, and the n net staffing impacts, generating a prompt; with the Gen AI model, using the prompt: for each SCR of the n SCRs, determining a respective priority; placing the n SCRs in order of their respective priorities; and for each SCR of the n SCRs, suggest a respective action to approve or decline the SCR. The system also includes updating the dynamic GUI on the manager computing device to display to a user, in the order of their respective priorities, the n SCRs and the n respective suggested actions. Other embodiments of this aspect include corresponding computer systems, apparatus, and computer programs recorded on one or more computer storage devices, each configured to perform the actions of the methods.

Implementations may include one or more of the following features. In some embodiments, fetching the n SCRs from the SCR database is automatic, such that each time a new SCR is received, the dynamic GUI is updated. In some embodiments, fetching the n SCRs from the SCR database is in response to a user input, such that each time the user input is received, the dynamic GUI is updated. In some embodiments, the operations further may include automatically updating the dynamic GUI of the manager computing device, and automatically querying the user to provide the user input. In some embodiments, the operations further may include, with a postprocessor, adding a respective link to at least one SCR of the n SCRs, and refactoring at least one SCR of the n SCRs to remove unimportant or redundant information. In some embodiments, the links provide respective user controls for each SCR of the n SCRs, enabling the user to manually approve or decline the SCR. In some embodiments, n is 5. In some embodiments, the prompt includes, for at least one SCR of the n SCRs, at least one of a request type, an agent's schedule, an agent comment or a historical approval pattern known to the Gen AI model, and where placing the n SCRs in the order of their respective priorities takes into account the request type, the agent's schedule, the agent comment, or the historical approval pattern for the at least one SCR of the n SCRs. In some embodiments, the operations further may include: if the respective suggested action for an SCR is to approve the SCR, automatically approving the SCR; or if the respective suggested action for an SCR is to decline the SCR, automatically declining the SCR. In some embodiments, fetching the n SCRs from the SCR database involves, with the Gen AI model, converting a natural language query into an SQL query. In some embodiments, each SCR that is neither approved nor declined is pending, and the operations further may include, continuously in real time, updating the dynamic GUI on an agent computing device of the plurality of agent computing devices to show whether an SCR associated with the agent computing device is approved, declined, or pending. In some embodiments, the operations further may include: with the Gen AI model, using the prompt, for each SCR of the n SCRs, generating a text observation; and updating the dynamic GUI on the manager computing device to display to the user, in the order of their respective priorities, the n text observations. In some embodiments, the operations further may include: if an SCR of the n SCRs has a respective deadline of today, updating the dynamic GUI on the manager computing device to notify the manager of the respective deadline. Implementations of the described techniques may include hardware, a method or process, or computer software on a computer-accessible medium.

One general aspect includes a method for automatically managing schedule change requests. The method includes, with a workforce management server having a processor and a non-transitory computer readable medium operably coupled thereto, the server being in electronic communication with a manager computing device and a plurality of agent computing devices, the processor having a query module, a net staffing calculator, a prompt generator, a generative artificial intelligence (Gen AI) model, and a dynamic graphical user interface (GUI), the server being in electronic communication with a schedule change request (SCR) database, a schedule database that includes a schedule, and a forecasting database: receiving, from the plurality of agent computing devices, a plurality of SCRs, each SCR having a respective agent name, respective requested date, and respective deadline. The method also includes storing the plurality of SCRs in the SCR database. The method also includes continuously, in real time: with the workforce management server, receiving, from an agent computing device of the plurality of agent computing devices, a new SCR, the new SCR having a respective deadline; storing the new SCR and its respective deadline in the SCR database; with the query module, fetching n SCRs from the SCR database whose deadlines are nearest; with the net staffing calculator, using the schedule database and the forecasting database, computing a respective net staffing impact for each SCR of the n SCRs; with the prompt generator, using the n SCRs, the n respective deadlines, and the n net staffing impacts, generating a prompt; with the Gen AI model, using the prompt: for each SCR of the n SCRs, determining a respective priority; placing the n SCRs in order of their respective priorities; and for each SCR of the n SCRs, suggest a respective action to approve or decline the SCR. The method also includes updating the dynamic GUI on the manager computing device to display to a user, in the order of their respective priorities, the n SCRs and the n respective suggested actions. Other embodiments of this aspect include corresponding computer systems, apparatus, and computer programs recorded on one or more computer storage devices, each configured to perform the actions of the methods.

Implementations may include one or more of the following features. In some embodiments, fetching the n SCRs from the SCR database is automatic, such that each time a new SCR is received, the dynamic GUI is updated. In some embodiments, fetching the n SCRs from the SCR database is in response to a user input, such that each time the user input is received, the dynamic GUI is updated. In some embodiments, the method may include: if the respective suggested action for an SCR is to approve the SCR, automatically approving the SCR; or if the respective suggested action for an SCR is to decline the SCR, automatically declining the SCR. In some embodiments, the dynamic GUI may include respective user controls for each SCR of the n SCRs, enabling the user to manually approve or decline the SCR. In some embodiments, each SCR that is neither approved nor declined is pending, and the method further may include, continuously in real time, updating the dynamic GUI on an agent computing device of the plurality of agent computing devices to show whether an SCR associated with the agent computing device is approved, declined, or pending. In some embodiments, the method may include: with the Gen AI model, using the prompt, for each SCR of the n SCRs, generating a text observation; and updating the dynamic GUI on the manager computing device to display to the user, in the order of their respective priorities, the n text observations. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the dynamic schedule change management system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is schematic, diagrammatic representation of the hardware architecture of an example dynamic schedule change management system, in accordance with at least one embodiment of the present disclosure.

FIG. 2 is an example screen display of a dynamic graphical user interface (GUI) of an example workforce management (WFM) system, in accordance with at least one embodiment of the present disclosure.

FIG. 3 is an example screen display of a dynamic graphical user interface (GUI) of an example dynamic schedule change management system, in accordance with at least one embodiment of the present disclosure.

FIG. 4 is an example screen display of a dynamic graphical user interface (GUI) of an example dynamic schedule change management system, in accordance with at least one embodiment of the present disclosure.

FIG. 5 is an example screen display of a dynamic graphical user interface (GUI) of an example dynamic schedule change management system, in accordance with at least one embodiment of the present disclosure.

FIG. 6 is a schematic, diagrammatic representation, in hybrid flow diagram/block diagram form, of an example dynamic schedule change management system, in accordance with at least one embodiment of the present disclosure.

FIG. 7 is a schematic, diagrammatic representation, in hybrid flow diagram/block diagram form, of an example dynamic schedule change management system, in accordance with at least one embodiment of the present disclosure.

FIG. 8 is an example AI prompt generation process for a prompt, in accordance with at least one embodiment of the present disclosure.

FIG. 9 is a schematic, diagrammatic representation of a software architecture of an example dynamic schedule change management system, in accordance with at least one embodiment of the present disclosure.

FIG. 10 is a schematic, diagrammatic representation of a software architecture of an example dynamic schedule change management system, in accordance with at least one embodiment of the present disclosure.

FIG. 11 is a component diagram of an example dynamic schedule change management system, in accordance with at least one embodiment of the present disclosure.

FIG. 12 is a component diagram of the schedule manager service of FIG. 10, in accordance with at least one embodiment of the present disclosure.

FIG. 13 is a component diagram of the workforce management schedule change manager microservice, in accordance with at least one embodiment of the present disclosure.

FIG. 14 is a schematic, diagrammatic representation, in block diagram form, of data structures and fata flow for an example dynamic schedule change management system, in accordance with at least one embodiment of the present disclosure.

FIG. 15 is a schematic, diagrammatic representation, in flow diagram form, of an example dynamic schedule change management method, in accordance with at least one embodiment of the present disclosure.

FIG. 16 is a schematic diagram of a processor circuit, in accordance with at least one embodiment of the present disclosure.

### DETAILED DESCRIPTION

In accordance with at least one embodiment of the present disclosure, a dynamic schedule change management system is provided which allows an agent manager to see a short list of the highest-priority schedule change requests (SCRs) (e.g., those with the closest deadlines), along with recommended actions for each SCR on the list. Each time a new SCR is filed or a current SCR is approved or denied, this list can be automatically and dynamically updated, such that the manager remains aware of changes in staffing priorities. The recommended actions are clickable, and can be implemented automatically if clicked.

The dynamic schedule change management system provides visibility for both agents and managers into the status of SCRs. For example, agents can see the status of their own requests, enabling them to plan their time off or extra hours effectively. This transparency helps in maintaining agent morale and satisfaction. Similarly, when using the dynamic schedule change management system, managers gain insight into staffing needs, and can adjust schedules proactively to ensure adequate coverage and balance of skills among agents. To address the challenges faced by managers using the Workforce Management (WFM) tool regarding pending requests and visibility, the following solutions, enhanced with AI-driven suggestions, are disclosed.

### 1. Ability to Sort Requests Based on Priority and Suggest Appropriate Actions

The system uses generative artificial intelligence (Gen AI) models to predict the urgency of each pending request. Factors such as request type, the agent's schedule, net staffing impact, agent comments sent with the requests, and historical approval patterns can be analyzed. Proactive reminders can be sent to the manager automatically for requests identified as critical or likely to impact operations. This helps to ensure that high-priority requests are addressed promptly, reducing the risk of operational disruptions. The manager can receive (either automatically or on demand) the highest-priority requests, sorted by priority, along with the actions recommended for them by the Gen AI large language model (LLM).

### 2. Automated Reminders and Notifications

Automated reminders can be issued to a manager for pending requests nearing their deadlines. Notification triggers can be set based on request submission dates and deadlines.

### 3. Workflow Automation

The approval process is streamlined through automation of routine tasks and decision-making steps. Clear approval workflows may be defined based on request types (time off, extra hours, trades, meetings, etc.), and appropriate approvers or escalation paths can be designated. AI models are integrated for intelligent decision-making. AI can identify requests that can be automatically approved based on predefined criteria (e.g., time off requests within certain limits, standard overtime hours). This can reduce the need for manual intervention for straightforward requests, making the approval process more efficient by speeding it up and saving management/supervisor time in reviewing and approving requests.

The system can be further enhanced with additional capabilities:

### 4. Analytical Insights

Analytics and reporting capabilities can be incorporated into the WFM tool to track trends, identify bottlenecks in the approval process, and measure the impact of delayed approvals on operations. Predictive analytics can be used to forecast future request volumes and workload distribution, and the system can recommend changes to approval rules or staffing strategies based on anticipated demand patterns and historical data analysis. This enables data-driven decision-making, improving overall operational efficiency.

### 5. Continuous Improvement

The system can encourage feedback from managers, agents, and other stakeholders to continuously improve the WFM tool's functionality and user experience. For example, AI-powered chatbots or virtual assistants within the WFM tool can provide instant support, answer frequently asked questions (FAQs), and gather feedback on user satisfaction and suggestions for enhancements. This may help ensure that the tool evolves based on user needs and feedback, leading to continuous improvement in decision-making speed and the accuracy thereof.

By implementing these solutions and leveraging AI-driven capabilities, the manager can enhance SCR management, improve visibility into pending requests, streamline approval workflows, and make real-time, data-driven decisions to optimize staffing and scheduling in the contact center. This comprehensive approach addresses the core challenges and ensures efficient and effective management of workforce resources.

The dynamic schedule change management system of the present disclosure stands out from existing Workforce Management (WFM) solutions through its integration of advanced AI-driven models specifically designed to predict the urgency of each pending request. By analyzing factors such as request type, agent schedules, and historical approval patterns, the system provides a level of precision and insight that traditional tools lack. Additionally, the present disclosure includes proactive reminders for critical requests and intelligent suggestions for refining approval rules-features that are not believed to be found in other WFM tools. While existing solutions may offer basic tracking and approval functionalities, the dynamic schedule change management system uniquely combines AI-driven urgency prediction with proactive notifications, workflow automation, and continuous improvement mechanisms. This holistic integration helps to ensure that all aspects of request management are optimized, leading to a more efficient, balanced, and satisfied workforce.

The novel exploitation of AI herein addresses specific operational pain points in contact centers, and goes beyond conventional methods for addressing such issues. The present disclosure leverages AI to not only predict urgency but also to automate workflows and provide ongoing improvement suggestions. These features require a deep understanding of both AI technology and the unique dynamics of workforce management, which are not combined in existing solutions. For example, traditional approaches might involve manual tracking and basic automation, but the present disclosure's use of AI to predict request urgency, automate routine tasks, and continuously refine approval processes, represents a significant leap forward. The integration of natural language processing (NLP) for analyzing comments and AI-driven forecasting models for staffing needs further distinguishes the dynamic schedule change management system from standard practices. These advanced capabilities require specialized knowledge and an innovative approach that goes beyond the conventional skill set of a typical software engineer.

Implementing this solution can predict the urgency of schedule change requests, significantly reducing the overhead of pending requests for managers. This streamlines the approval process for agents and minimizes operational burdens for managers. The dynamic schedule change management system may for example include a “schedule change request prioritized engine,” i.e., a service (e.g., a java-based service) which analyzes the impact of agent time-off requests, and which takes multiple parameters as input like net staffing, list of agents with skill association and schedule change requests. This engine runs the AI model, and generates output in the form of insights. The system includes multiple engines to convert text to SQL and then generate a prompt for the LLM by providing the inputs required to get the insights of a prioritized list of schedule change requests (SCRs), which can then be presented to the manager through a dynamic GUI, and updated in real time each time an agent files a new SCR, or, in some embodiments, each time the manager approves or denies a current SCR.

The present disclosure aids substantially in the technical problem of schedule management, by improving a staffing manager's insight into which schedule change requests are the most urgent and/or the most impactful. Implemented on a workforce management server in communication with a manager computer and multiple agent computers, the dynamic schedule change management system disclosed herein provides practical improvement in the time required to analyze and approve/reject new schedule change requests, as well minimizing the chance of impactful errors that negatively affect staffing levels for key skill units. This improved processing of change requests transforms an SCR database into a short list (e.g., a 5-item list) of the SCRs that are most critical for the manager to review, without the normally routine need to manually review the entire database of pending SCRs. This unconventional approach improves the functioning of the workforce management server, by dramatically reducing the amount of computer time required for a manager to identify and address critical SCRs. This reduction in computer time also reduces energy consumption and the greenhouse gas emissions associated therewith.

The dynamic schedule change management system may be implemented as a process at least partly viewable on a display, and operated by a control process executing on a processor that accepts user inputs, e.g., from a keyboard, mouse, trackpad, touchscreen or other interface, and that is in communication with one or more databases. In that regard, the control process performs certain specific operations in response to different inputs or selections made at different times. Certain outputs of the dynamic schedule change management system may be printed, shown on a display, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the dynamic schedule change management system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

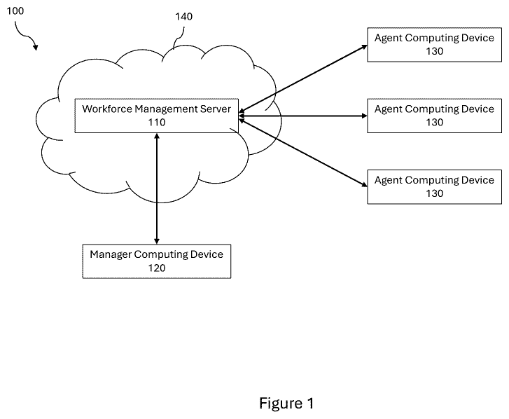

FIG. 1 is schematic, diagrammatic representation of the hardware architecture 100 of an example dynamic schedule change management system, in accordance with at least one embodiment of the present disclosure. In the example shown in FIG. 1, a workforce management server 110 is in bidirectional communication (e.g., over a local area network such as an Ethernet network, or a wide area network such as the Internet) with a manager computing device 120 and several agent computing devices 130. Depending on the implementation, the workforce management server 110 may be a virtual computer running on a cloud server 140. It is noted that each of the workforce management server 110, the manager computing devices 120, and the agent computing devices 130 should be considered particular rather than generic machines, in that they are customized (whether through hardware, software, firmware, or combinations thereof) for the functions described herein. Furthermore, the hardware architecture 100 is itself a particular machine, in that the dynamic schedule change management system cannot perform the functions described herein without at least one instance of each component 110, 120, and 130. Thus, the dynamic schedule change management system may itself be considered a particular machine rather than a generic computing system.

Before continuing, it should be noted that the examples described above are provided for purposes of illustration, and are not intended to be limiting. Other devices and/or device configurations may be utilized to carry out the operations described herein.

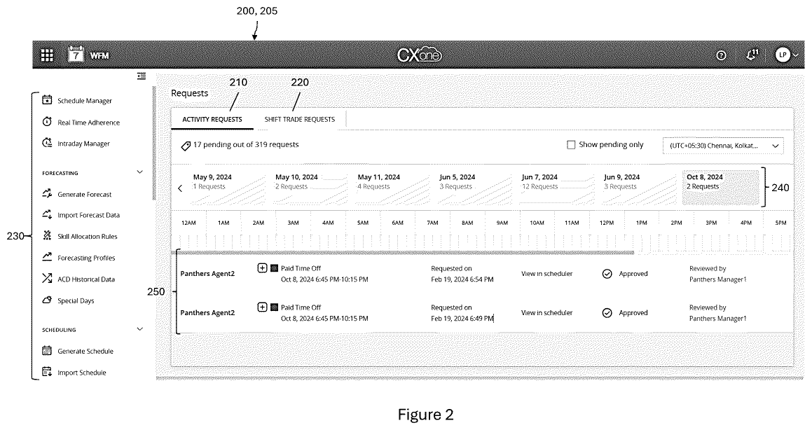

FIG. 2 is an example screen display 200 of a dynamic graphical user interface (GUI) 205 of an example workforce management (WFM) system, in accordance with at least one embodiment of the present disclosure. In the example shown in FIG. 2, the screen display 200 includes an “activity requests” tab 210, a “shift trade requests” tab 220, a functions menu 230, a list 240 of pending SCRs organized by date, and a list 250 of SCRs arranged by the time for which each request was filed.

The GUI 205 is specifically designed to help the manager handle schedule change activity requests and shift trade requests submitted by agents. The manager uses this interface to oversee and manage requests from agents who need to change their scheduled activities. The interface allows the manager to view all incoming schedule change requests in an organized manner, making it easier to track and address each request. The manager also manages trade requests through this interface. Trade requests occur when agents wish to swap their scheduled shifts or activities with one another. The GUI provides a clear and concise way for the manager to view and process these trade requests, ensuring that they are handled efficiently. To facilitate effective decision-making, the interface includes a detailed view 250 sorted by date. This date-wise view 250 allows the manager to see all requests for a particular date, along with relevant details such as the agent's name, current schedule, requested changes, and any notes provided by the agents. Within this detailed view, the manager can approve or decline requests as needed. Each request can be individually assessed based on the details provided and the overall impact on the schedule. The GUI 205 includes options for the manager to approve or decline each request directly from the detailed view 250. This streamlined process ensures that the manager can quickly respond to requests, maintaining an efficient workflow.

However, the screen display 200 does not include any prioritization of existing or incoming SCRs.

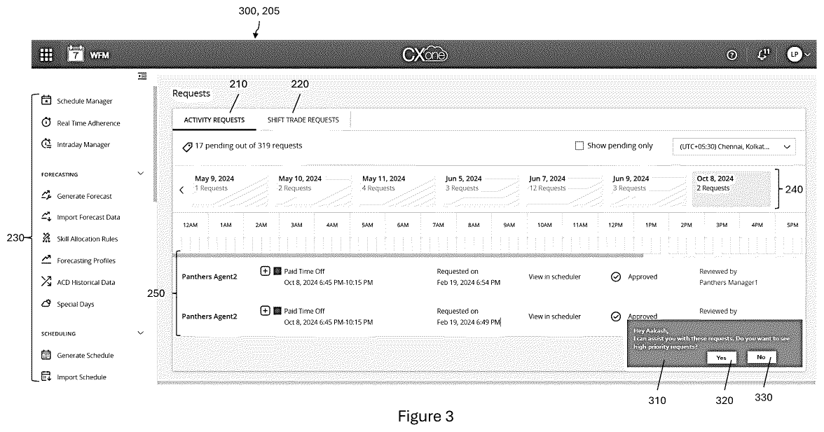

FIG. 3 is an example screen display 300 of a dynamic graphical user interface (GUI) 205 of an example dynamic schedule change management system, in accordance with at least one embodiment of the present disclosure. Visible are the “activity requests” tab 210, the “shift trade requests” tab 220, the functions menu 230, the list 240 of pending SCRs organized by date, and the list 250 of SCRs arranged by the time for which each request was filed. However, in the example shown in FIG. 3, the screen display 300 also includes a dialogue box 310 asking the user whether they would like to see the high-priority schedule change requests. The dialogue box includes a Yes button 320 (or other affirmative indicator), which may for example activate the dynamic schedule change management system of the present disclosure, and a No button 330 (or other negative indicator), which may for example remove the dialogue box from the screen display 300.

By displaying messages to the manager in a prompt format, the interface 205 allows the manager to engage with the functions of the dynamic schedule change management system. As shown below, interface 205 will also provide suggestions for potential changes, where the manager has the discretion to accept or ignore these suggestions. These recommendations are generated based on comprehensive analysis and precise calculations carried out according to the methods described herein.

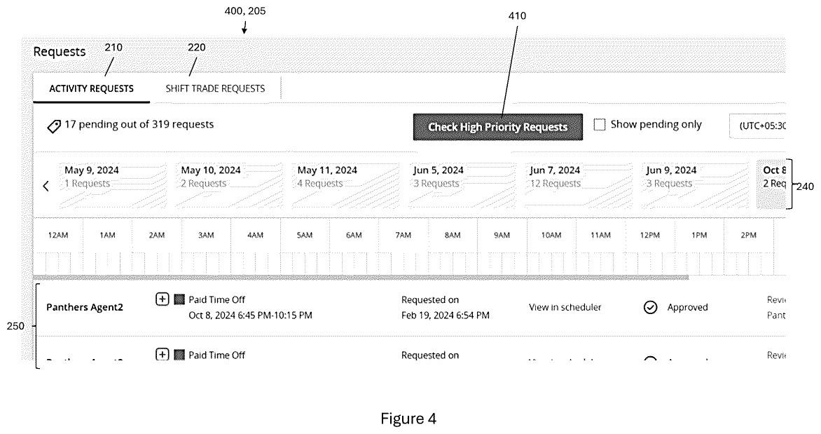

FIG. 4 is an example screen display 400 of a dynamic graphical user interface (GUI) 205 of an example dynamic schedule change management system, in accordance with at least one embodiment of the present disclosure. Visible are the “activity requests” tab 210, the “shift trade requests” tab 220, the list 240 of pending SCRs organized by date, and the list 250 of SCRs arranged by the time for which each request was filed. However, in the example shown in FIG. 4, there is also a button 410 that allows the user to check high-priority SCRs. Generally speaking, high-priority SCRs are those SCRs that have the soonest due dates.

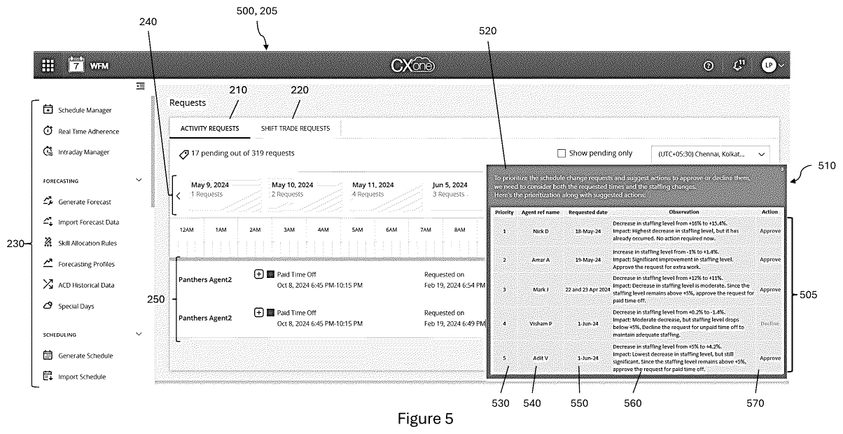

FIG. 5 is an example screen display 500 of a dynamic graphical user interface (GUI) 205 of an example dynamic schedule change management system, in accordance with at least one embodiment of the present disclosure. Visible are the “activity requests” tab 210, the “shift trade requests” tab 220, the functions menu 230, the list 240 of pending SCRs organized by date, and the list 250 of SCRs arranged by the time for which each request was filed. However, in the example shown in FIG. 5, the GUI 205 also displays a priority SCR pop-up window 510 showing, in this example, the top 5 highest-priority SCRs 505. The pop-up window 510 includes a text explanation 520. In addition, each SCR 505 in the pop-up window 510 includes a ranked priority 530, the name 540 of the agent associated with the request, a requested date or range of dates 550, an observation 560 generated by the dynamic schedule change management system, and a recommended action 570.

The observations 560 may be expressed in natural language, and may for example include the effect that approving the SCR would have on overall staffing levels, or staffing levels for a particular skill group, plus an explanation of the recommended action. Other information may also be included regarding anything unusual or noteworthy about the SCR. The recommended action will generally consist of either “approve” (if the staffing impact is minimal or otherwise acceptable) or “decline” (if the staffing impact places staffing levels below a specified margin), although other actions (e.g., “discuss with agent”, “suggest different date”, etc.) may be included without departing from the spirit of the present disclosure.

This example GUI design showcases a system for managing activity requests with a focus on prioritizing and acting on the most important schedule change requests. A goal of the dynamic schedule change management system is to streamline the process of handling schedule change requests by providing a clear, prioritized list along with actionable insights. This helps the manager in making informed decisions quickly and efficiently, and to quickly review and act on schedule change requests. It is noted that the GUI shown and described herein is exemplary, and that the same or similar information could be displayed in myriad other ways without departing from the spirit of the present disclosure. In some embodiments, the GUI 205 may also include options to filter and display pending requests based on time zones or other considerations.

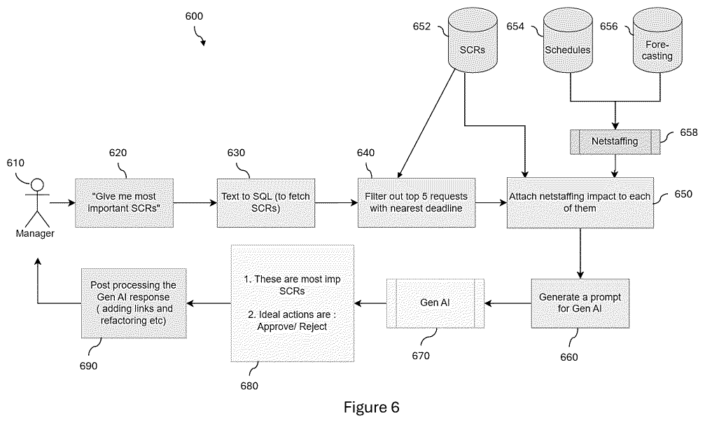

FIG. 6 is a schematic, diagrammatic representation, in hybrid flow diagram/block diagram form, of an example dynamic schedule change management system 600, in accordance with at least one embodiment of the present disclosure.

In an initiation step 620, the WFM manager 610 requests a prioritized list of the most important SCRs. This may be done for example by clicking on button 410 of FIG. 4 or button 320 of FIG. 3, by asking a chatbot, etc.

In a conversion step 630, the manager's request is converted into a database query (e.g., an SQL query), and an SCR database 652 is queried to retrieve all pending SCRs (e.g., SCRs that have not yet been approved or declined) for agents managed by the manager 610.

In a filtering step 640, the top n SCRs (e.g., the n SCRs with the soonest deadlines) are filtered out and added to a list. The value of n may for example be 5, although other values may be used instead or in addition.

In an impact assessment step 650, a net staffing module 658 is queried for each of the n high-priority SCRs. The net staffing module 658 queries a schedules database 654 (which may for example include the schedules for all agents) and a forecasting database 656 (which may for example include demand forecasts based on time of day, day of week, upcoming holidays, etc.) to determine the effect each SCR will have on the total staffing level, either for the entire contact center, for a particular skill group within the contact center, or for only the agents managed by the manager 610. Impact may for example be assessed as follows:
Get Net-staffing for the requested SCR interval:
Required Agents (from forecast database 656)
Scheduled Agents (from schedule database 654)

$$Current Netstaffing = [ \text{} ( Required Agents - Scheduled Agents ) * 100 ] \text{} / ( Required Agents )$$

$$Calculate the new net staffing if SCR gets approved :$$

$$New Scheduled Agents for Timeoff = Scheduled Agents - 1$$

$$New Scheduled Agents for Extra hours = Scheduled Agents + 1$$

$$New Netstaffing = [ \text{} ( Required Agents - New Scheduled Agents ) * 100 ] \text{} / ( Required Agents )$$

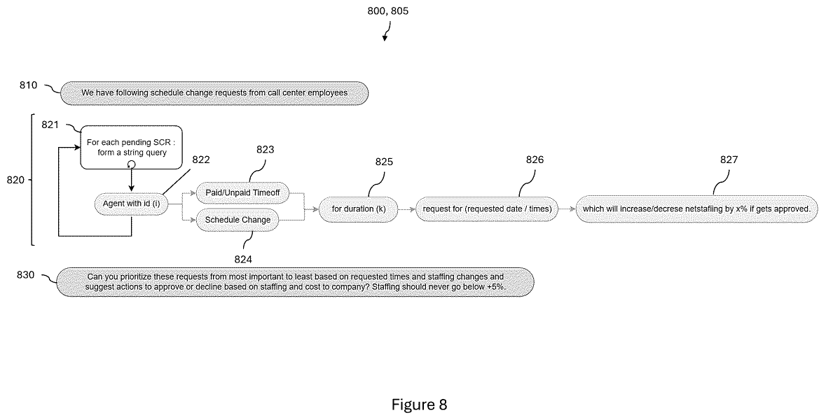

In a prompt generation step 660, the top n SCRs, and their staffing impacts, are used to generate a large language model (LLM) prompt, as described below in FIG. 8. This prompt is then passed to a GenAI LLM 670, which produces a tabular or natural language list response 680 that includes the n SCRs, a description of their staffing impacts, and recommended actions for each SCR.

In a post-processing step 690, the dynamic schedule change management system adds links to approve or decline each SCR, as well as refactoring the list, e.g., removing unimportant or redundant information from the list response. The post-processed list of the n SCRs, including natural language comments regarding staffing impacts and other factors, is then passed back to the manager 610 (e.g., as shown in FIG. 5).

An example of an SCR, appended with net staffing impacts and expressed in JSON format, is shown below:

```
SCR Object:
{
  ″requestUuid″ : <requestUuid>,
  ″userUuid″ : <userUuid>,
  ″userName″ : “Mark D″,
  ″creationTime″ : ″2023-11-07T03:34:23Z″,
  ″startTime″ : ″2023-11-06T18:30:00Z″,
  ″endTime″ : ″2023-11-07T18:29:59Z″,
  ″requestedChanges″ : {
  },
  ″requestedScheduleData″ : {
    }
  },
  ″originalScheduleData″ : {
    ″userUuid″ : <userUuid>,
    ″shifts″ : [ ],
    ″activityIntervals″ : [ ]
  },
  ″status″ : ″PENDING″,
  ″statusUpdaterUuid″ : null,
  ″statusUpdaterName″ : null,
  ″statusUpdateComment″ : null,
  ″revision″ : 1,
  ″activityChangeRequests″ : [ ],
  ″originalNetstaffing″:″2.3″,
  ″newNetstaffingAfterApproval″:″2.1″
}
```

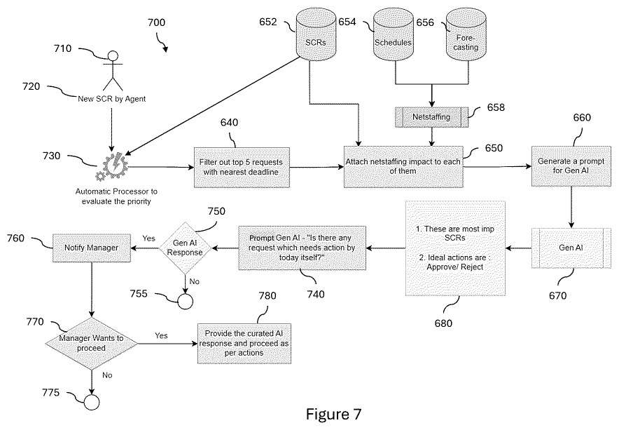

FIG. 7 is a schematic, diagrammatic representation, in hybrid flow diagram/block diagram form, of an example dynamic schedule change management system 600, in accordance with at least one embodiment of the present disclosure.

In an initiation step 720, an agent 710 files a new schedule change request.

In a prioritization step 730, the new SCR is compared against the SCR database 652, e.g., against pending SCRs (e.g., SCRs that have not yet been approved or declined) to determine a priority for the new SCR relative to the pending SCRs.

In a filtering step 640, the top n SCRs (e.g., the n SCRs with the soonest deadlines) are filtered out and added to a list. The value of n may for example be 5, although other values may be used instead or in addition.

In an impact assessment step 650, a net staffing module 658 is queried for each of the n high-priority SCRs. The net staffing module 658 queries a schedules database 654 (which may for example include the schedules for all agents) and a forecasting database 656 (which may for example include demand forecasts based on time of day, day of week, upcoming holidays, etc.) to determine the effect each SCR will have on the total staffing level, either for the entire contact center, for a particular skill group within the contact center, or for only the agents managed by the manager 610. Impact may for example be assessed as follows:

In a prompt generation step 660, the top n SCRs, and their staffing impacts, are used to generate a large language model (LLM) prompt, as described below in FIG. 8. This prompt is then passed to a GenAI LLM 670, which produces a tabular or natural language list response 680 that includes the n SCRs, a description of their staffing impacts, and recommended actions for each SCR.

In an urgency management step 740, the LLM output 680 is fed back the LLM 670 with a question, asking whether any of the n highest-priority SCRs are due today. The LLM then outputs a yes or no response 750. If the response 750 is no, then execution proceeds to step 755, where the process is complete, and no further action is taken until a new SCR is entered into the system.

If the response 750 is yes, then in a notification step 760, the manager is notified that there is at least one SCR that needs to be addressed today. In a querying step 770, the manager is then prompted whether they would like to proceed (as shown for example in FIG. 3). If the manager responds with a no, then execution proceeds to step 775, where the process is complete, and no further action is taken until a new SCR is entered into the system.

If the manager responds with a yes, then in a display step 780, the LLM-curated response 680 is provided to the manager as shown for example in FIG. 5.

FIG. 8 is an example AI prompt generation process 800 for a prompt 805, in accordance with at least one embodiment of the present disclosure. In the example shown in FIG. 8, the prompt 805 is a natural language, multi-sentence prompt that includes an introduction 810 explaining what the prompt 805 is about, and a question 830, asking the LLM to prioritize the SCRs based on their requested times and their associated staffing impacts, and to recommend an action (e.g., approve or decline) for each SCR. The question 830 may also include constraints, such as “staffing should never go below +5%”.

In between the introduction 810 and the question 830 is a list 820 of the n SCRs, arranged by a loop 820. For each SCR, the list 820 includes an agent ID 822, and an indication of whether the SCR is a paid or unpaid time off request 823 or a schedule change 824 such as a shift swap. For each SCR, the list 820 also includes the requested dates and/or times 826, and a natural language description of the staffing impact 827.

The resulting prompt can be passed to a Gen AI LLM to produce the output list (e.g., output 680 of FIGS. 6 and 7). An example prompt passed by the dynamic schedule change management system to a third-party LLM such as Chat-GPT is as follows:
“We have following schedule change requests from call center employees:
agent2 requested paid time off of 1 hour 18 May 2024 which will decrease staffing level from +12% to +11%.
agent1 requested paid time off of 8 hours 19 May 2024 which will decrease staffing level from +5% to +4.2%.
agent3 requested sick leave of 2 days for 22 and 23 Apr. 2024 which had decreased staffing level from +16% to +15.4%.
agent4 requested extra work of 0.5 hours for 1 Jun. 2024 which will increase staffing level from −1% to +1.4%.
agent5 requested unpaid time off of 3 hours for 1 Jun. 2024 which will decrease staffing level from +0.2% to −1.4%.
Can you prioritize these requests from most important to least based on requested times and staffing changes and suggest actions to approve or decline based on staffing and cost to company? Staffing should never go below +5%.”

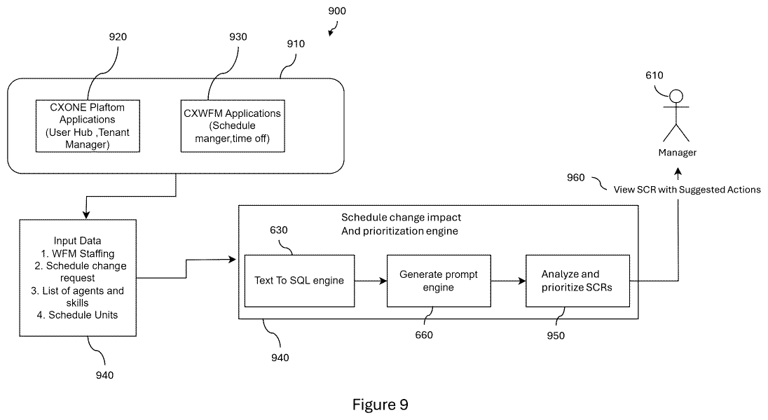

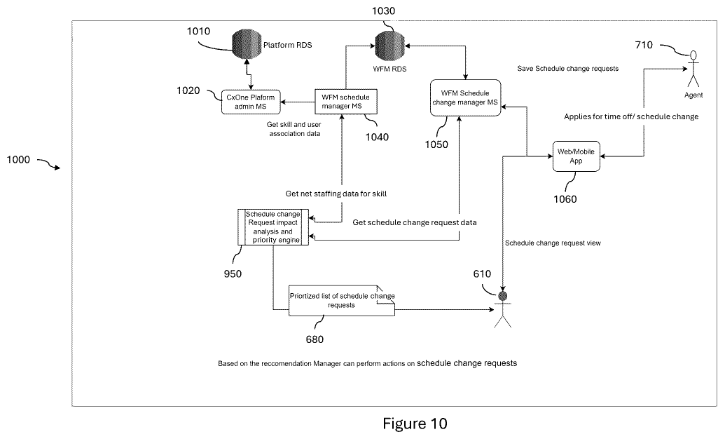

FIG. 9 is a schematic, diagrammatic representation of a software architecture 900 of an example dynamic schedule change management system, in accordance with at least one embodiment of the present disclosure. The software architecture includes a contact center host 910 running a Contact Center as a Service (CCaaS) system 920 and a contact center workforce management (CXWFM) system 930. In an example, the CCaaS system 920 includes both agent applications and manager applications, as well as multiple cross-suite applications like ACD (Automatic Call Distributor) and WFM (Work force management). The CXWFM system 930 may for example be hosted Amazon Web Service (AWS), and serves as a data source. The CXWFM system 930 includes a schedule manager and a schedule change request manager, described in further detail in FIG. 10, below. The contact center host 910 produces input data 940 that is passed to a schedule impact and prioritization engine 940. In the example shown in FIG. 9, the input data 940 includes WFM staffing levels and projections, a list or database of pending schedule change requests, a list or database of agents and their skills, and a list or database of schedule units or scheduling units. A scheduling unit organizes employees into groups with common scheduling requirements, including the operating days and hours of the unit, which may have more than one working shift. For example, a scheduling unit may include groups of employees working specific shifts in a specific location or employees working in a specific department.

The schedule impact and prioritization engine 940 includes a text to SQL engine 630, a prompt generation engine 660, and an engine 950 to analyze and prioritize SCRs as described above. The engine 950 may for example be a java-based service which analyzes the impact of agent time-off requests, communicated with the LLM, and generates output in the form of insights. These outputs (e.g., a list 960 of the 5 most urgent SCRs and their schedule impacts and suggested actions) are then passed to the manager 610 via the manager computing device 120 (see FIG. 1), in a screen display such as that shown in FIG. 5.

FIG. 10 is a schematic, diagrammatic representation of a software architecture 1000 of an example dynamic schedule change management system, in accordance with at least one embodiment of the present disclosure. The software architecture includes a platform remote desktop service or platform database 1010 which stores information about agents and their scheduling units' details, and which communicates with a CCaaS platform administration microservice 1020. The software architecture also includes a workforce management remote desktop service 1030, which receives data from a WFM schedule manager microservice 1040, which is in communication with the CCaaS platform administration microservice 1020 and the SCR impact analysis and priority engine 950. The workforce management remote desktop service 1030 also communicates with a WFM schedule change manager microservice 1050.

In an example, an agent 710 (e.g., via an agent computing device 130 of FIG. 1) requests time off, or another type of schedule change through a web application or mobile application 1060. This SCR is then passed to the WFM schedule change manager microservice 1050, which passes it to the schedule change request impact analysis and priority engine 950. The schedule change request impact analysis and priority engine 950 then fetches skill and user association data, and net staffing data for the agent's skill groupings, from the WFM schedule manager microservice 1040. The schedule change request impact analysis and priority engine 950 then outputs a prioritized list 680 of schedule change requests, which can be viewed by the manager 610 via the web application or mobile application 1060 (e.g., via the manager computing device 120 of FIG. 1).

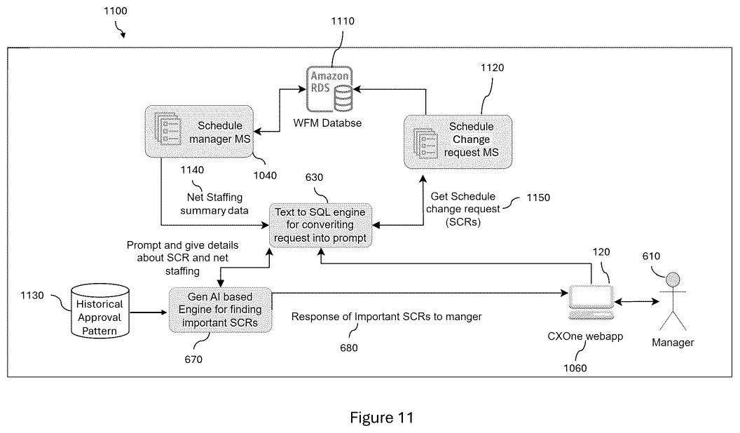

FIG. 11 is a component diagram 1100 of an example dynamic schedule change management system, in accordance with at least one embodiment of the present disclosure. The component diagram 1100 includes a WFM database 1110, which is in two-way communication with the schedule manager microservice 1040, and which receives data from the schedule change request microservice. In the example shown in FIG. 11, the manager 610, via a web application 1060 accessed via the manager computing device 120, requests to see the highest-priority SCRs. A text-to-SQL conversion engine 630 pulls schedule change requests from the SCR microservice 1120, and pulls net staffing summary data 1140 from the schedule manager microservice 1040. The text-to-SQL conversion engine 630 then generates a prompt and passes it to the Gen AI engine or LLM 670, which uses the prompt, plus a historical approval pattern 1130 for SCRs (e.g., a ground-truth database of past SCRs, their net staffing impacts, and their actual approval or rejection by managers), to generate a response 680 (e.g., a prioritized list of important SCRs), which is then passed back to the manager 610 via the web app 1060 accessed through the manager computing device 120. The historical approval pattern may for example be or include session data stored by the LLM 670.

In an example, the components 1110, 1120, 1040, and 630 may be deployed on the AWS private network with restricted access rules. The Gen AI based engine 670 may depend on input data received from different WFM microservices which are deployed as AWS elastic container service (ECS) containers and using AWS remote desktop service (RDS) as data storage.

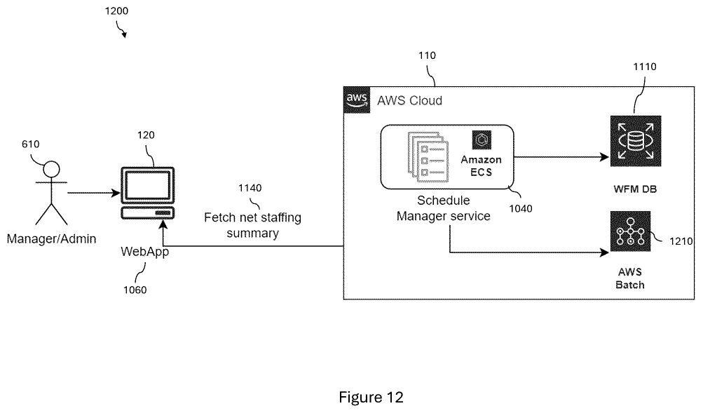

FIG. 12 is a component diagram 1200 of the schedule manager service 1040 of FIG. 10, in accordance with at least one embodiment of the present disclosure. In an example, the manager or administrator 610 accesses the web application 1060 via the manager computing device 120 to fetch a net staffing summary 1140. The schedule manager service 1040 runs on the WFM server 110, and communicates with a WFM database 1110 and an AWS batch service 1210. The schedule manager service 1040 may for example be a Java-based Spring Boot microservice that operates within the AWS cloud infrastructure, leveraging ECS for containerized deployment. By distributing its containers across multiple availability zones, the service may help ensure resilience against failures by maintaining redundant instances across distinct physical locations. The core functionality of the schedule manager service revolves around generating staffing summaries based on historical forecasted requirements, which serve as the basis for scheduling agents' work shifts. This may for example involve an asynchronous process driven by user inputs, where staffing data is computed in response to forecasted demands using AWS Batch service 1210.

The schedule manager service or schedule manager microservice 1040 exposes a comprehensive set of representational state transfer application program interfaces (REST APIs), enabling users to retrieve detailed information about net staffing summaries per specified intervals. These APIs support various filters such as WFM skills, agents, and scheduling units, allowing for precise querying and analysis.

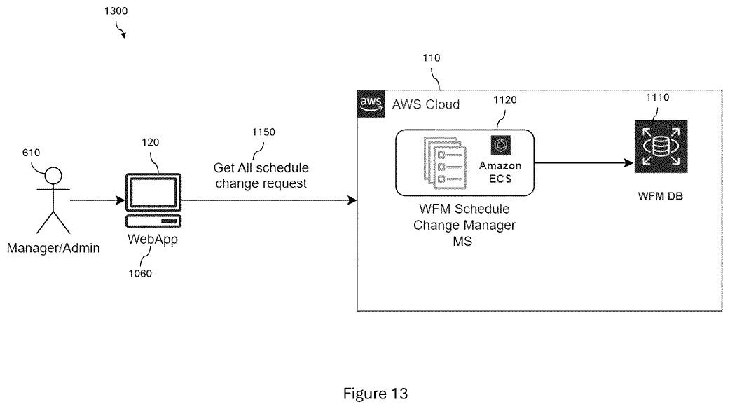

FIG. 13 is a component diagram 1300 of the workforce management schedule change manager microservice 1120, in accordance with at least one embodiment of the present disclosure. In an example, the manager or administrator 610 accesses the web application 1060 via the manager computing device 120 to fetch all pending schedule change requests 1150. The request is passed to the workforce management schedule change manager microservice 1120, which runs on the WFM server 110 and communicates with the WFM database 1110. The workforce management schedule change manager microservice 1120 may for example be a Java-based Spring Boot microservice that operates within the AWS cloud infrastructure, leveraging ECS (Elastic Container Service) for containerized deployment. By distributing its containers across multiple availability zones, the service ensures resilience against failures by maintaining redundant instances across distinct physical locations. The core functionality of the workforce management schedule change manager microservice 1120 revolves around saving and fetching schedule change requests submitted by an agent, using REST APIs.

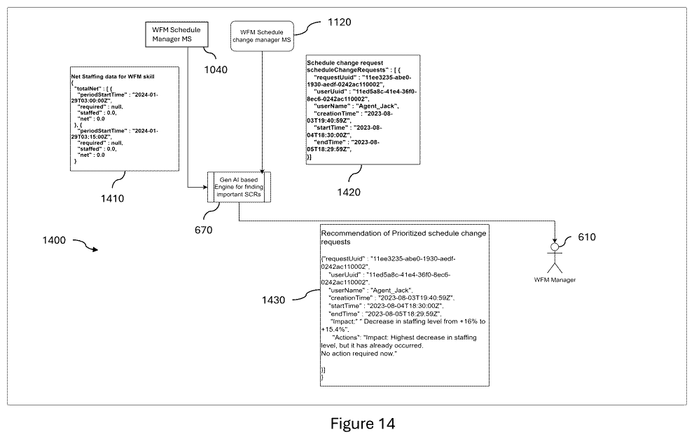

FIG. 14 is a schematic, diagrammatic representation 1400, in block diagram form, of data structures and fata flow for an example dynamic schedule change management system, in accordance with at least one embodiment of the present disclosure. In an example, the WFM schedule manager microservice 1040 passes data from a Net Staffing Data per Interval data structure 1410 to the LLM 670 in the form of a prompt. This dataset presents a summary of net staffing levels per 15-minute interval, offering valuable insights into the workforce management (WFM) scheduling process. By detailing the staffing requirements at regular intervals, it enables the WFM engine to accurately determine the necessary workforce allocation for each time segment. This information is essential for optimizing resource allocation, ensuring adequate staffing levels to meet operational demands, and ultimately enhancing efficiency and productivity within the organization. An example of the data structure 1410 is shown below:

```
{
  ″totalNet″ : [ {
    ″periodStartTime″ : ″2024-01-29T03:00:00Z″,
    ″required″ : null,
    ″staffed″ : 0.0,
    ″net″ : 0.0
  }, {
    ″periodStartTime″ : ″2024-01-29T03:15:00Z″,
    ″required″ : null,
    ″staffed″ : 0.0,
    ″net″ : 0.0
  }
```

In an example, the WFM schedule change manager microservice 1120 passes data from a WFM Schedule Change Request data structure, in the form of a prompt, to the LLM 670. This dataset includes user and interval details for schedule change requests within the Workforce Management (WFM) system. Leveraging the previously mentioned data sets, the engine can identify the user associated with the request, the affected intervals, and subsequently determine the user's Automatic Call Distribution (ACD) skill (e.g., the skill or skills which are assigned to a user by the ACD application, which may map to WFM skills in a one-to-many form). Additionally, by referencing staffing requirements data, the engine can assess the impact of the schedule change on ACD skill service level agreements (SLAs, where the service level setting for a skill defines the target for how quickly to handle the contacts). This comprehensive analysis enables organizations to anticipate staffing adjustments, ensure adherence to ACD skill SLAs, and maintain optimal operational performance in response to schedule changes. An example of the data structure 1420 is as follows:

```
{″requestUuid″ : ″11ee3235-abe0-1930-aedf-0242ac110002″,
  ″userUuid″ : ″11ed5a8c-41e4-36f0-8ec6-0242ac110002″,
  ″userName″ : ″Agent_Jack″,
  ″creationTime″ : ″2023-08-03T19:40:59Z″,
  ″startTime″ : ″2023-08-04T18:30:00Z″,
  ″endTime″ : ″2023-08-05T18:29:59Z″,
}]
```

In an example, the LLM passes a Prioritized Schedule Change Request data structure 1430 to the manager 610 (via the LLM as shown in FIG. 6). This feature provides detailed insights into the impact of schedule change requests on staffing and prioritized these schedule request with appropriate actions. By analyzing each schedule change request, the system generates a mitigation plan tailored to address potential impacts on staffing and prioritizes these schedule requests. These insights offer proactive strategies to mitigate any adverse effects on staffing and on which the WFM manager can take action, ensuring efficient workforce management and maintaining high-quality service delivery. This functionality empowers organizations to anticipate and address scheduling challenges effectively, minimizing disruptions and optimizing operational performance. An example of the data structure 1430 is as follows:

### Recommendation of Prioritized Schedule Change Requests

{″requestUuid″ : ″11ee3235-abe0-1930-aedf-0242ac110002″,
″userUuid″ : ″11ed5a8c-41e4-36f0-8ec6-0242ac110002″,
″userName″ : ″Agent_Jack″,
″creationTime″ : ″2023-08-03T19:40:59Z″,
″startTime″ : ″2023-08-04T18:30:00Z″,
″endTime″ : ″2023-08-05T18:29:59Z″,
″Impact:″ ″ Decrease in staffing level from +16% to +15.4%″,
″Actions″: ″Impact: Highest decrease in staffing level, but it has already occurred.
No action required now.″
}]

The following is an example interaction with the LLM 670:
Input query:
“We have following schedule change requests from call center employees:
agent2 requested paid time off of 1 hour 18 May 2024 which will decrease staffing level from +12% to +11%.
agent1 requested paid time off of 8 hours 19 May 2024 which will decrease staffing level from +5% to +4.2%.
agent3 requested sick leave of 2 days for 22 and 23 Apr. 2024 which had decreased staffing level from +16% to +15.4%.
agent4 requested extra work of 0.5 hours for 1 Jun. 2024 which will increase staffing level from −1% to +1.4%.
agent5 requested unpaid time off of 3 hours for 1 Jun. 2024 which will decrease staffing level from +0.2% to −1.4%.
Can you prioritize these requests from most important to least based on requested times and staffing changes and suggest actions to approve or decline based on staffing and cost to company? Staffing should never go below +5%.”
Output:
“To prioritize the schedule change requests and suggest actions to approve or decline them, we need to consider both the requested times and the staffing changes. We'll prioritize requests based on their impact on staffing levels, ensuring that the staffing never goes below +5%. Here's the prioritization along with suggested actions:
Agent3: Sick Leave (22 and 23 Apr. 2024)
Decrease in staffing level from +16% to +15.4%.
Impact: Highest decrease in staffing level, but it has already occurred. No action required now.
Agent4: Extra Work (1 Jun. 2024)
Increase in staffing level from −1% to +1.4%.
Impact: Significant improvement in staffing level. Approve the request for extra work.
Agent2: Paid Time Off (18 May 2024)
Decrease in staffing level from +12% to +11%.
Impact: Decrease in staffing level is moderate. Since the staffing level remains above +5%, approve the request for paid time off.
Agent5: Unpaid Time Off (1 Jun. 2024)
Decrease in staffing level from +0.2% to −1.4%.
Impact: Moderate decrease but staffing level drops below +5%. Decline the request for unpaid time off to maintain adequate staffing.
Agent1: Paid Time Off (19 May 2024)
Decrease in staffing level from +5% to +4.2%.
Impact: Lowest decrease in staffing level, but still significant. Since the staffing level remains above +5%, approve the request for paid time off.
Priority order: Agent3>Agent4>Agent2>Agent5>Agent1”

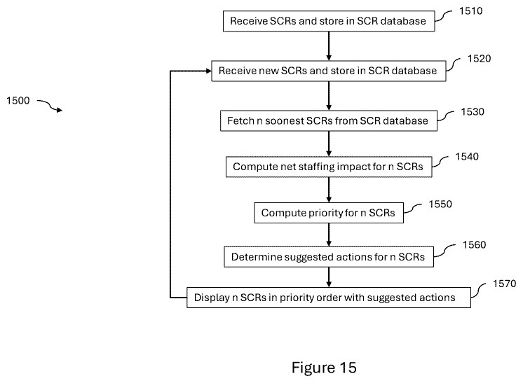

FIG. 15 is a schematic, diagrammatic representation, in flow diagram form, of an example dynamic schedule change management method 1500, in accordance with at least one embodiment of the present disclosure. It is understood that the steps of method 1500 may be performed in a different order than shown in FIG. 15, additional steps can be provided before, during, and after the steps, and/or some of the steps described can be replaced or eliminated in other embodiments. One or more of steps of the method 1500 can be carried by one or more devices and/or systems described herein, such as components of the system 100, system 600, system 700, and/or processor circuit 1650.

In step 1510, the method 1500 includes, over a period of time, receiving SCRs and storing them in the SCR database. Execution then proceeds to step 1520.

It is noted that steps 1520 through 1570 occur continuously, in real time, to dynamically update the manager's display each time a new SCR is entered into the system by an agent.

In step 1520, the method 1500 includes receiving a new SCR and storing it in the SCR database. Execution then proceeds to step 1530.

In step 1530, the method 1500 includes fetching the n SCRs (e.g., 5 SCRs) that have the soonest due dates. Execution then proceeds to step 1540.

In step 1540, the method 1500 includes computing the net staffing impact of each of the n SCRs. Execution then proceeds to step 1550.

In step 1550, the method 1500 includes computing a relative priority for each of the n SCRs. Execution then proceeds to step 1560.

In step 1560, the method 1500 includes determining a suggested action for each of the n SCRs. Execution then proceeds to step 1570.

In step 1570, the method 1500 includes displaying (e.g., on the manager computing device) the n SCRs in priority order, along with their suggested actions. Execution then returns to step 1520 when a new SCR is received.

Flow diagrams and block diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, block diagrams may show a particular arrangement of components, modules, models, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, to avoid an impression of lag, within 1 second of a new SCR being entered into the system by an agent, the staffing impact of the SCR may need to be calculated, a new query may need to be constructed and sent to the LLM, a response received, and the manager's display updated. Such rapid calculation and real-time dynamic display of information cannot be performed by a human.

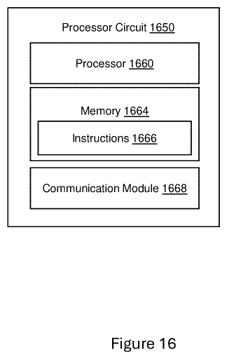

FIG. 16 is a schematic diagram of a processor circuit 1650, in accordance with at least one embodiment of the present disclosure. The processor circuit 1650 may form a portion of the WFM server 110, manager computing device 120, agent computing device 130 or other components of the system 100. As shown, the processor circuit 1650 may include a processor 1660, a memory 1664, and a communication module 1668. These elements may be in direct or indirect communication with each other, for example via one or more buses.

The processor 1660 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1660 may also include another hardware device, a firmware device, or any combination thereof configured to perform the operations described herein. The processor 1660 may also be implemented as a combination of computing devices, e.g., a combination of a DSP and a microprocessor, a plurality of microprocessors, one or more microprocessors in conjunction with a DSP core, or any other such configuration.

The memory 1664 may include a cache memory (e.g., a cache memory of the processor 1660), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1664 includes a non-transitory computer-readable medium. The memory 1664 may store instructions 1666. The instructions 1666 may include instructions that, when executed by the processor 1660, cause the processor 1660 to perform the operations described herein. Instructions 1666 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1668 can include any electronic circuitry and/or logic circuitry to facilitate direct or indirect communication of data between the processor circuit 1650, and other processors or devices. In that regard, the communication module 1668 can be an input/output (I/O) device. In some instances, the communication module 1668 facilitates direct or indirect communication between various elements of the processor circuit 1650 and other components of the system 100. The communication module 1668 may communicate within the processor circuit 1650 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or communication with a third-party LLM) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the dynamic schedule change management system advantageously provides a workforce manager with dynamic, real-time information regarding high-priority schedule change requests, their expected schedule impacts, and an automated recommendation as to whether to approve or decline each request. Accordingly, it can be seen that the dynamic schedule change management system fills a long-standing need in the art, by addressing a top complaint of contact center managers.

A number of variations are possible on the examples and embodiments described above. For example, the dynamic screen display could include any number of high-priority SCRs, from displaying only the single highest-priority SCR, to displaying 2-10 SCRs, to displaying as many high-priority SCRs as will fit on a single screen. However, displaying 5 SCRs as a time may be preferred, as this number is manageable, easily displayed, and can have a meaningful impact on addressing the body of outstanding SCRs. The cloud hosting service may be something other than AWS. In some embodiments, the WFM server may be local to the contact center, rather than being hosted on the cloud. The Generative AI engine may be or include a third-party large language model, or may be or include a custom large-language model tailored specifically to the needs of the dynamic schedule change management system. The SCR database, schedules database, forecasting database, historical approval pattern database, and/or other databases may be SQL databases, noSQL databases, or otherwise. The technology described herein may be applied not only to contact centers, but to any business where minimum staffing levels are required, and where schedule change requests therefore have a potentially large impact on the performance of the business. Examples include shopping malls, medical systems, mechanical/chemical industrial plants, and other businesses/companies with minimum staffing requirements depending on the time of day.

Accordingly, the logical operations making up the embodiments of the technology described herein are referred to variously as operations, steps, blocks, objects, layers, elements, components, services, microservices, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the dynamic schedule change management system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the dynamic schedule change management system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically manage schedule change requests, the system comprising:
a workforce management server having a processor and a non-transitory computer readable medium operably coupled thereto, the server being in electronic communication with a manager computing device and a plurality of agent computing devices, the processor comprising a query module, a net staffing calculator, a prompt generator, a generative artificial intelligence (Gen AI) model, and a dynamic graphical user interface (GUI), the server being in electronic communication with a schedule change request (SCR) database, a schedule database comprising a schedule, and a forecasting database, the computer readable medium comprising a plurality of instructions stored in association therewith that are accessible to, and executable by, the processor, to perform operations which comprise:
with the workforce management server, receiving, from the plurality of agent computing devices, a plurality of SCRs, each SCR having a respective agent name, requested date, and deadline;
storing the plurality of SCRs in the SCR database; and
continuously, in real time:
with the workforce management server, receiving, from an agent computing device of the plurality of agent computing devices, a new SCR, the new SCR having a respective deadline;
storing the new SCR and its respective deadline in the SCR database;
with the query module, fetching n SCRs from the SCR database whose deadlines are nearest;
with the net staffing calculator, using the schedule database and the forecasting database, computing a respective net staffing impact for each SCR of the n SCRs;
with the prompt generator, using the n SCRs, the n respective deadlines, and the n net staffing impacts, generating a prompt;
with the GenAI model, using the prompt:
for each SCR of the n SCRs, determining a respective priority;
placing the n SCRs in order of their respective priorities; and
for each SCR of the n SCRs, suggest a respective action to approve or decline the SCR; and
updating the dynamic GUI on the manager computing device to display to a user, in the order of their respective priorities, the n SCRs and the n respective suggested actions.

2. The system of claim 1, wherein fetching the n SCRs from the SCR database is automatic, such that each time a new SCR is received, the dynamic GUI is updated.

3. The system of claim 1, wherein fetching the n SCRs from the SCR database is in response to a user input, such that each time the user input is received, the dynamic GUI is updated.

4. The system of claim 3, wherein the operations further comprise automatically updating the dynamic GUI of the manager computing device, automatically querying the user to provide the user input.

5. The system of claim 1, wherein the operations further comprise, with a postprocessor, adding a respective link to at least one SCR of the n SCRs, and refactoring at least one SCR of the n SCRs to remove unimportant or redundant information.

6. The system of claim 5, wherein the links provide respective user controls for each SCR of the n SCRs, enabling the user to manually approve or decline the SCR.

7. The system of claim 1, wherein n is 5.

8. The system of claim 1, wherein the prompt includes, for at least one SCR of the n SCRs, at least one of a request type, an agent's schedule, an agent comment or a historical approval pattern known to the GenAI model, and wherein placing the n SCRs in the order of their respective priorities takes into account the request type, the agent's schedule, the agent comment, or the historical approval pattern for the at least one SCR of the n SCRs.

9. The system of claim 1, wherein the operations further comprise:
if the respective suggested action for an SCR is to approve the SCR, automatically approving the SCR; or
if the respective suggested action for an SCR is to decline the SCR, automatically declining the SCR.

10. The system of claim 1, wherein fetching the n SCRs from the SCR database involves, with the GenAI model, converting a natural language query into an SQL query.

11. The system of claim 1, wherein each SCR that is neither approved nor declined is pending, and wherein the operations further comprise, continuously in real time, updating the dynamic GUI on an agent computing device of the plurality of agent computing devices to show whether an SCR associated with the agent computing device is approved, declined, or pending.

12. The system of claim 1, wherein the operations further comprise:
with the GenAI model, using the prompt, for each SCR of the n SCRs, generating a text observation; and
updating the dynamic GUI on the manager computing device to display to the user, in the order of their respective priorities, the n text observations.

13. The system of claim 1, wherein the operations further comprise: if an SCR of the n SCRs has a respective deadline of today, updating the dynamic GUI on the manager computing device to notify the manager of the respective deadline.

14. A method for automatically managing schedule change requests, which method comprises:
with a workforce management server having a processor and a non-transitory computer readable medium operably coupled thereto, the server being in electronic communication with a manager computing device and a plurality of agent computing devices, the processor comprising a query module, a net staffing calculator, a prompt generator, a generative artificial intelligence (Gen AI) model, and a dynamic graphical user interface (GUI), the server being in electronic communication with a schedule change request (SCR) database, a schedule database comprising a schedule, and a forecasting database:
receiving, from the plurality of agent computing devices, a plurality of SCRs, each SCR having a respective agent name, respective requested date, and respective deadline;
storing the plurality of SCRs in the SCR database; and
continuously, in real time:
with the workforce management server, receiving, from an agent computing device of the plurality of agent computing devices, a new SCR, the new SCR having a respective deadline;
storing the new SCR and its respective deadline in the SCR database;
with the query module, fetching n SCRs from the SCR database whose deadlines are nearest;
with the net staffing calculator, using the schedule database and the forecasting database, computing a respective net staffing impact for each SCR of the n SCRs;
with the prompt generator, using the n SCRs, the n respective deadlines, and the n net staffing impacts, generating a prompt;
with the GenAI model, using the prompt:
for each SCR of the n SCRs, determining a respective priority;
placing the n SCRs in order of their respective priorities; and
for each SCR of the n SCRs, suggest a respective action to approve or decline the SCR; and
updating the dynamic GUI on the manager computing device to display to a user, in the order of their respective priorities, the n SCRs and the n respective suggested actions.

15. The method of claim 14, wherein fetching the n SCRs from the SCR database is automatic, such that each time a new SCR is received, the dynamic GUI is updated.

16. The method of claim 14, wherein fetching the n SCRs from the SCR database is in response to a user input, such that each time the user input is received, the dynamic GUI is updated.

17. The method of claim 14, further comprising:
if the respective suggested action for an SCR is to approve the SCR, automatically approving the SCR; or
if the respective suggested action for an SCR is to decline the SCR, automatically declining the SCR.

18. The method of claim 14, wherein the dynamic GUI comprises respective user controls for each SCR of the n SCRs, enabling the user to manually approve or decline the SCR.

19. The method of claim 14, wherein each SCR that is neither approved nor declined is pending, and wherein the method further comprises, continuously in real time, updating the dynamic GUI on an agent computing device of the plurality of agent computing devices to show whether an SCR associated with the agent computing device is approved, declined, or pending.

20. The method of claim 14, further comprising:
with the GenAI model, using the prompt, for each SCR of the n SCRs, generating a text observation; and
updating the dynamic GUI on the manager computing device to display to the user, in the order of their respective priorities, the n text observations.
